(19) United States
(12) Patent Application Publication
(10) Pub. No.: US 2006/0088503 A1
(43) Pub. Date: Apr. 27, 2006

(54) Cellular and genetic intervention to treat ventricular tachycardia

(76) Inventors: Vinod Sharma, Blaine, MN (US); Orhan Soykan, Shoreview, MN (US); Maura G. Donovan, St. Paul, MN (US); Walter H. Olson, North Oaks, MN (US)

Correspondence Address: MEDTRONIC, INC., 710 MEDTRONIC PARK, MINNEAPOLIS, MN, 55432-9924, US

(21) Appl. No.: 11/249,948

(22) Filed: Oct. 13, 2005

Related U.S. Application Data
(60) Provisional application No. 60/618,423, filed on Oct. 13, 2004.

(51) Int. Cl. A01N 63/00

(52) U.S. Cl. 424/93.2

(57) ABSTRACT

A method for decreasing risk of ventricular tachycardia following myocardial infarction increases cell-to-cell coupling and/or excitability in the border zone of an infarcted region of myocardial tissue. Enhanced conduction to treat the border zone is carried out by genetically modifying myocytes in the border zone to form more gap junctions and/or sodium channels and/or calcium channels. Alternatively, enhanced conduction is carried out by incorporating cells into the border zone that form gap junctions with the myocytes and/or form sodium channels and/or form calcium channels.

### BACKGROUND OF THE INVENTION

The present invention relates to methods for treating ventricular tachycardia (VT). In particular, the present invention relates to methods for treating an infarct to suppress or eliminate substrate for VT. In patients with a history of myocardial infarction, rapid sustained VT can lead to sudden cardiac death, which is a major problem worldwide.

Many individuals that have suffered myocardial infarction are left to contend with infarct related complications. One of the major complications for these individuals is a propensity to experience monomorphic VT.

A number of treatments are currently used to reduce VT that is associated with infarcted myocardium (VTI) in these patients. Catheter ablation is a common treatment strategy that has been successful for some classes of arrhythmias, but its success has been less than spectacular for a majority of ventricular arrhythmias. VTI ablation is fairly straightforward when the VT can be easily induced in the electrophysiological lab and is hemodynamically stable. Unfortunately, this is the case for only a minority of the VT episodes. Moreover, even when the VTI is successfully ablated, the same VTI or a different VTI can recur in a vast majority of the patients.

Drugs have also been used as a common treatment strategy with limited success. Drug toxicity and unanticipated side effects usually plague most pharmalogical approaches.

Implantable cardioverter-defibrillators (ICDs) are currently the most effective therapy for patients with a history of ventricular tachycardia/ventricular fibrillation. Antitachycardia pacing (ATP) therapy, available on most modern ICDs, can be quite effective in painlessly treating monomorphic VT, which is the most common form of ventricular arrhythmia afflicting ICD patients. See M S. Wathen et al., Circulation 104(7):796-801. However, various perceptions surrounding ATP therapy have made acceptance of ATP therapy for treating VT relatively low. The most prevalent among these is the notion that an ATP failure leads to delay in delivery of eventual high-voltage therapy and possibly increased incidence of patient syncope. Thus, high voltage therapy is still the mainstay of ICD therapies used for treating VT.

In patients experiencing infrequent VT episodes, using high-voltage therapy instead of ATP has little untoward consequences except that high-voltage therapy can be uncomfortable and associated with greater patient anxiety and hospitalization. However, in patients experiencing storms of VT episodes, delivery of high-voltage therapy in rapid succession can lead to increased patient discomfort and quicker depletion of the device battery necessitating replacement procedures. Thus, there is a need for improved treatment of VTI.

### BRIEF SUMMARY OF THE INVENTION

The present invention treats an electrical conduction disturbance that develops after myocardial infarction. Biological material delivered to the border zone of the infarct eliminates or ameliorates substrate for VT by enhancing electrical conduction via increased cell-to-cell coupling and/or improved cellular excitability.

### BRIEF DESCRIPTION OF THE DRAWINGS

FIG. 1 is a schematic diagram of a figure-of-8 model and conduction in normal myocardium.

FIGS. 2a and 2b are schematic diagrams of a figure-of-8 model and conduction for a VT initiating wave front in diseased myocardium.

FIG. 3 is a schematic diagram of a cross-section through infarcted myocardium.

FIG. 4 is a schematic diagram illustrating genetic intervention.

FIG. 5 is a schematic diagram of an expression cassette.

FIG. 6 is a schematic diagram of a viral expression construct.

FIG. 7 is a schematic diagram illustrating cellular intervention.

FIG. 8 is a schematic illustration of a first embodiment of a self-fixating scaffold.

FIG. 9 is a schematic diagram of a second embodiment of a self-fixating scaffold.

FIG. 10 is a schematic illustration of a third embodiment of a self-fixating scaffold.

FIG. 11 is a schematic illustration of a fourth embodiment of a self-fixating scaffold.

FIG. 12 is a schematic illustration of a fifth embodiment of a self-fixating scaffold.

FIG. 13 is a flowchart representing embodiments of the present invention.

### DETAILED DESCRIPTION

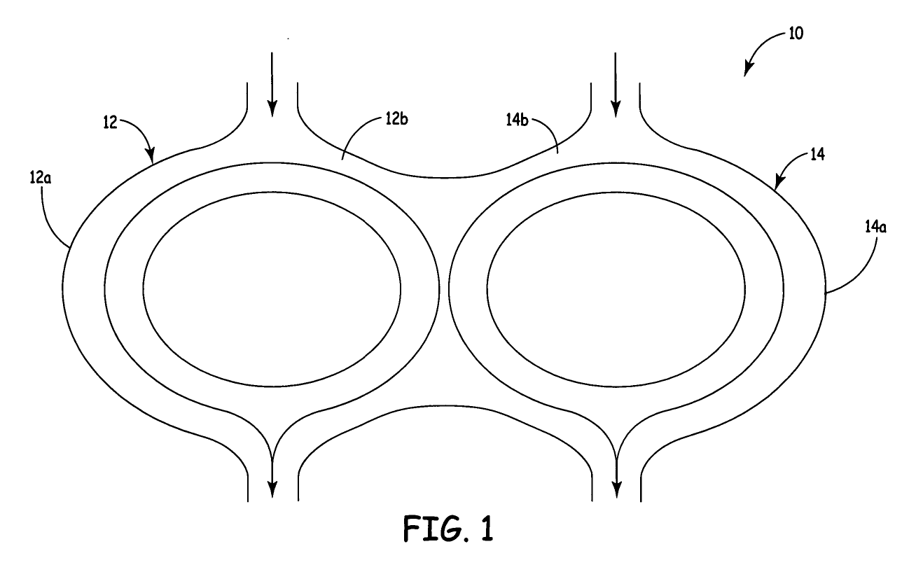

The Inventors suggest that the genesis and pathogenic maintenance of monomorphic VT typically associates with an infarcted region of diseased myocardium fundamentally in the form of reentrant activity around the periphery of the infarct. Reentry is reexcitation of a region of cardiac tissue by a given impulse that continues for one or more cycles. Reentry exists over an anatomical area of slowed conduction and where the tissue shows abnormal refractoriness to stimulation, thus producing a substrate for unidirectional conduction block. The initiation and maintenance mechanism of VT can be understood using figure-of-8 model 10 as shown in FIG. 1. Model 10 includes rings 12 and 14. Arms 12a and 12b of ring 12 and arms 14a and 14b of ring 14 represent distinct (hypothetical) myocardial tracts within the myocardial tissue. FIG. 1 illustrates electrical activity in normal myocardium where propagation of electrical activity in arms 12a, 12b, 14a, and 14b is rapid and almost synchronous. As a result, the wave fronts collide and continue down the myocardium instead of continuing around rings 12 and 14, which would be described as reentrant activity. Furthermore, even if reentrant activity were somehow initiated, it would not be sustained, because the wavelength ( [symbol] [symbol] APD* c), which is a product of action potential duration (APD) and conduction velocity (c), in normal myocardium far exceeds the physical dimensions of a normal sized heart.

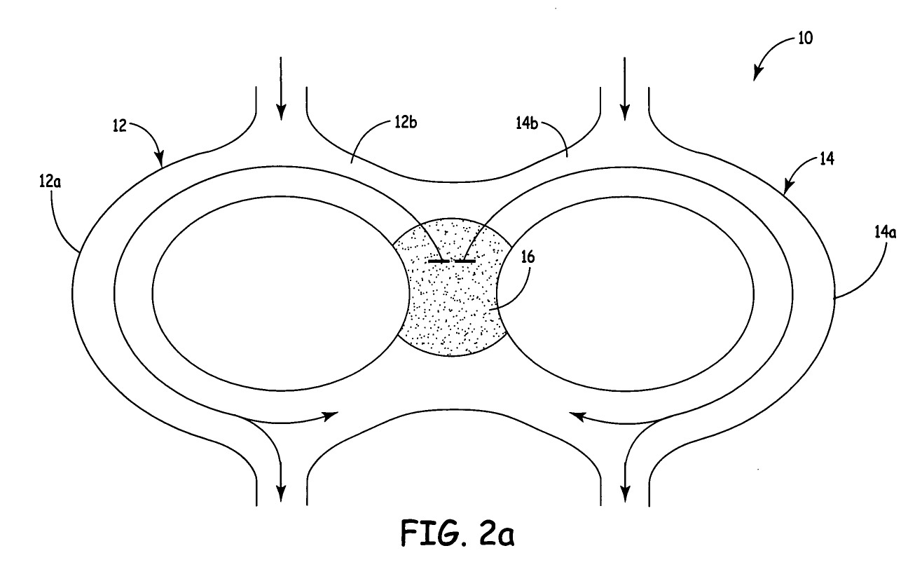

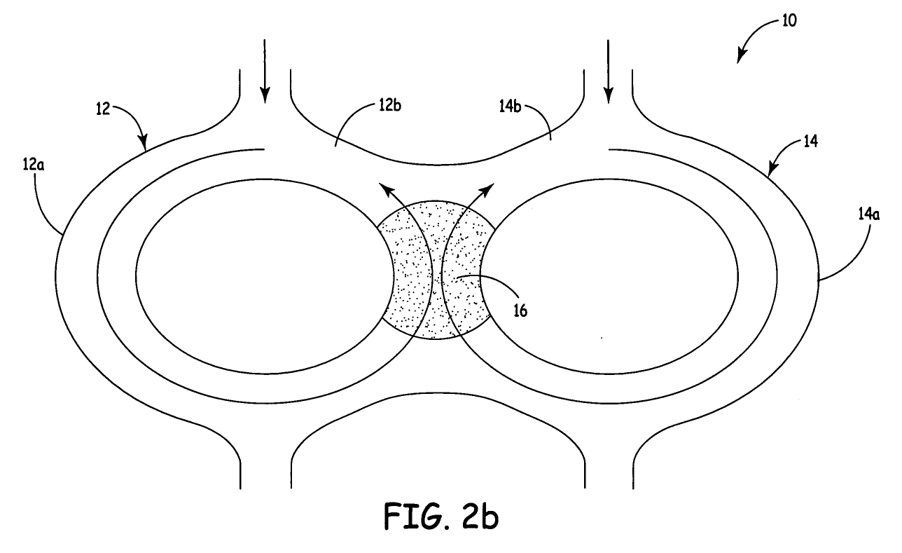

In a diseased heart, however, with VTI related heterogeneities, several changes occur that allow for reentrant activity to initiate and be sustained. FIGS. 2a and 2b show electrical activity in an infarcted myocardium. FIGS. 2a and 2b show model 10, as above, but also include infarcted region 16. The unidirectional block caused by infarcted region 16 prevents wave fronts from proceeding down arms 12b and 14b, while allowing wave fronts from arms 12a and 14a to proceed through arms 12b and 14b. Slowed propagation of the wave fronts through infarcted region 16 effectively shortens the wavelength, □, of the wave fronts allowing the reentrant activity to fit within the dimensions of the normal sized heart. Thus, the reentrant activity is sustained.

A major cause of VTI initiation and perpetuation is decreased electrical conduction in the border zone of an infarct. At a cellular level, the myocardial tissue remodels such that a layer of electrophysiologically normal cells survive at the endocardial and/or epicardial region. This viable layer of tissue abuts the central necrotic core and is referred to as the border zone. Morphologically, the tissue disarray in the border zone forms tracts of viable cells with abrupt expansion or narrowing. Such geometries have been shown to induce unidirectional block because of source-sink mismatch, which is a necessary ingredient for VT initiation. See S. Rohr, et al., Science 275:841-4.

At a molecular level, cells in the border zone show disarray in gap junctions thereby resulting in decreased cell-to-cell coupling. The decreased coupling manifests as slowed propagation of electrical activity at a macroscopic scale.

Gap junctions are composed mainly of protein subunits called connexins. Typically, six connexins form a connexon, or hemichannel, at the surface of a cell. The coupling of connexons between neighboring cells form gap junctions. Connexins are encoded by the Cx gene family and include numerous isoforms. Cx43, for example, is a major isoform found in cardiac atrial and ventricular tissue. However, other isoforms are also found in cardiac tissue.

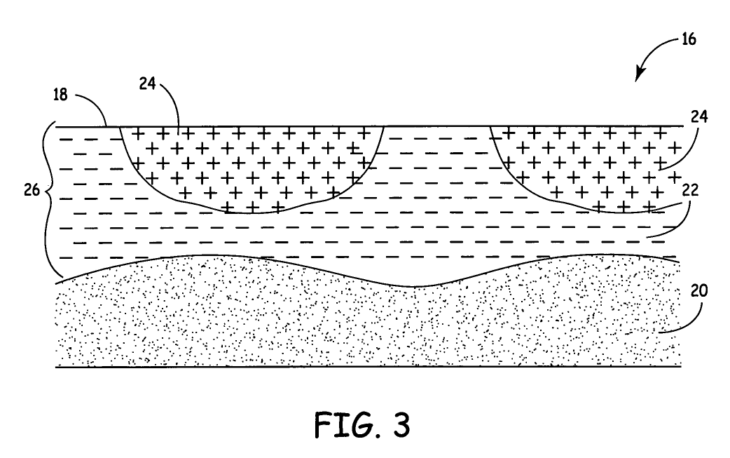

Gap junction changes in the border zone are schematically shown in FIG. 3. FIG. 3 shows a cross section of infarct region 16 with endocardium 18. Infarct region 16 also includes necrotic layer 20, gap junction disarray layer 22, and normal layer 24. Border zone 26 consists of two layers—normal layer 24 with normal coupling and gap junction disarray layer 22, which is usually deeper and shows gap junction abnormalities. In areas of infarct region 16 that are most susceptible to VT, layer 24 is not contiguous and instead breaks at places where the deeper layer 22 reaches endocardium 18.

Previous studies showed that an isthmus of a reentrant VT circuit (infarcted region 16 of FIG. 1) and endocardial/epicardial regions of maximal gap junction disarray spatially correlate. Electrical mapping identified the isthmus and serial sectioning and immunohistochemistry identified regions with gap junction disarray. The two regions corresponded to the same areas. See N. S. Peters et al., Circulation 97:1746-54, 1998.

The same group measured intercellular conductance in enzymatically dissociated cell pairs from the border zone using a double voltage clamp technique. The conductance measurements demonstrated that coupling between cells derived from the border zone decreased by an order of magnitude (100 ns for normal myocytes versus 10 ns for border zone myocytes) See J. A. Yao et al., Circ Res 92:437-43, 2003.

In addition to gap junctions, decreased excitability of the border zone region also plays a role in conduction abnormalities. Sodium and calcium channels contribute towards excitation. Voltage-gated sodium channels drive the initial depolarization phase of the cardiac action potential, which determines conduction of excitation through the heart. Individuals with deletions or loss-of-function mutations in the cardiac sodium channel gene, SCN5A, are at increased risk for ventricular fibrillation. See G. A. Papadatos, et al., PNAS 99(9):6210-15. Increased expression of sodium channels in cardiac tissue is described in U.S. Pat. No. 6,665,563, assigned to Medtronic, Inc.

Gap junction disarray causes decreased coupling between cells in the border zone resulting in compromised wave front conduction. The present invention enhances effective electrical conduction in the border zone by increasing coupling between cells through gap junctions. In addition, the present invention enhances the expression of sodium and/or calcium channels in the infarct border zone to improve excitability of the border zone cells. Improved cell-to-cell coupling and excitability are presumed to work synergistically in enhancing conduction in the border zone region.

Cellular excitability can be enhanced by genetically engineering the cells in the border zone to overexpress subunits of cardiac sodium and/or cardiac calcium channels. The α-subunit of sodium channels and at least some calcium channels is the main pore forming unit of these heteromeric channels.

Cellular coupling and excitability among cells in the border zone can be enhanced using one or a combination of the following two methods. In the first method, cardiac cells, or myocytes, in the border zone are genetically engineered to increase expression of connexin and/or sodium channel and/or calcium channel protein. Connexin 43 is used with the present invention, because it is the most abundant connexin in the ventricles. Connexin 40 is also used, because it presumably has the largest unitary conductance. However, any of the other connexin isoforms, including cardiac connexin 45 and other non-cardiac isoforms, may also be used for repairing the border zone. The α-subunits of the sodium and at least some of the calcium channels may also be used, because they are the main subunits forming the channels. Subunits other than α-subunits may also be used to form channels.

Moreover, methods known to indirectly increase gap junction conductance can be used, such as peptides (such as angiotensin 11 or endothelin) known to increase expression of endogenous gap junction channels. This could be accomplished by ex vivo gene transfer with a gene encoding for angiotensin 11 or endothelin or via direct gene transfer of the gene encoding for angiotensin II/endothelin. See S. Dhein, Peptides 23(9):1701-9.

In the second method, cells capable of forming gap junctions with myocytes and/or cells that express sodium and/or calcium channels are introduced into the border zone. Cells that form gap junctions couple with the myocytes and act as bridges to provide alternate pathways for current flow and to enhance effective coupling in the border zone region. Cells that express sodium and/or calcium channels increase excitability in the border zone.

The biological material used for repair is delivered specifically to the border zone of an infarct. In particular, the biological material is delivered to the endocardial border zone where the regions of slow conduction that initiate and sustain VT are most likely to occur. Nevertheless, the present invention is not limited to the repair of endocardial border zone only, and can be extended to other mid-myocardial or epicardial regions of the myocardium that may have abnormal conduction and form substrates for reentrant activity. Moreover, this invention could also be used to treat other forms of arrhythmias associated with conduction block (e.g. AV nodal block).

The biological material is comprised of nucleic acid, protein, cells, or a combination thereof. The function of the biological material, regardless of form, is to enhance conduction within the border zone by increasing the number of gap junctions and/or sodium/calcium currents, which are the primary currents responsible for cellular excitability in cardiac cells. This may be accomplished either through genetic or cellular intervention.

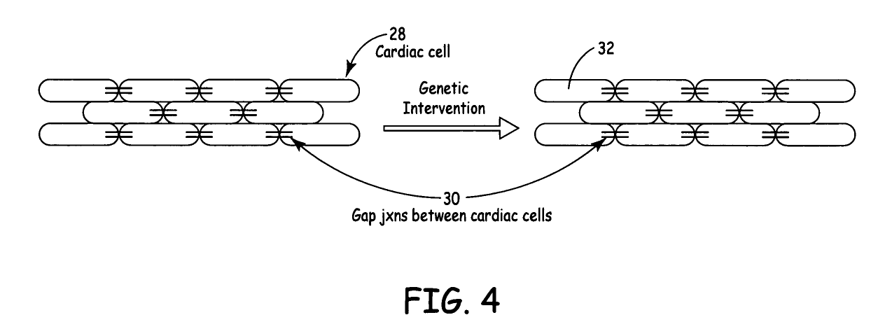

FIG. 4 is a schematic representation of genetic intervention. Cardiac cells or myocytes 28 represent cells in the border zone prior to genetic intervention. Cardiac cells 28 include gap junctions 30a and sodium/calcium channels 30b. There may be overlap of gap junctions 30a and channels 30b. In fact, sodium channels were shown to co-localize in cardiac myocytes with the connexin 43 isoform at the intercalated disks. See S. K. Maier et al., Circulation 109(11):1421-7. Cardiac cells 28 are modified, which results in recombinant cells 32. Recombinant cells 32 include more gap junctions 30a represented by the increased width of the interconnect between cells 32 and more channels 30b. The additional gap junctions 30a formed by cells 32 may have an increased propensity to form at the ends of the cells or may form more randomly around the cell periphery. Sodium/calcium channels 30b may or may not be expressed in combination with connexin proteins, such as connexin 43. In either case, the increased coupling and/or excitability result in enhanced electrical conduction.

Modification is typically through nucleic acid modification, but connexin and/or sodium/calcium channel proteins may also be delivered to the cells to form channels on the surface of the cardiac cells. For example, connexin 43 protein; connexin 40 protein; sodium channel (α-subunits); calcium channel subunits, such as L-type calcium channel (α-subunits) or T-type calcium channel subunits; or a combination thereof may be expressed in vitro and subsequently delivered to cells of the border zone.

For nucleic acid modification, one or more vectors that include one or more of the Cx43 gene, Cx40 gene, other Cx isoform genes, sodium channel (α-subunit) gene, or calcium channel subunit gene may be delivered to the border zone to transfect cardiac cells 28. The resulting recombinant cells 32 either have the exogenous nucleic acid incorporated into the genome of the cells, or transiently or stably maintained as an episomal element. Recombinant cells 32 may enhance the level of connexin and/or sodium/calcium channel protein expression up to normal levels or may overexpress the proteins. Nucleic acid modification may be performed by any of a number of methods that are known to those skilled in the art and utilize any form of DNA or RNA. In addition, cardiac cells 28 may be transfected, or transformed, with additional regulatory elements such as promoters, enhancers, etc.

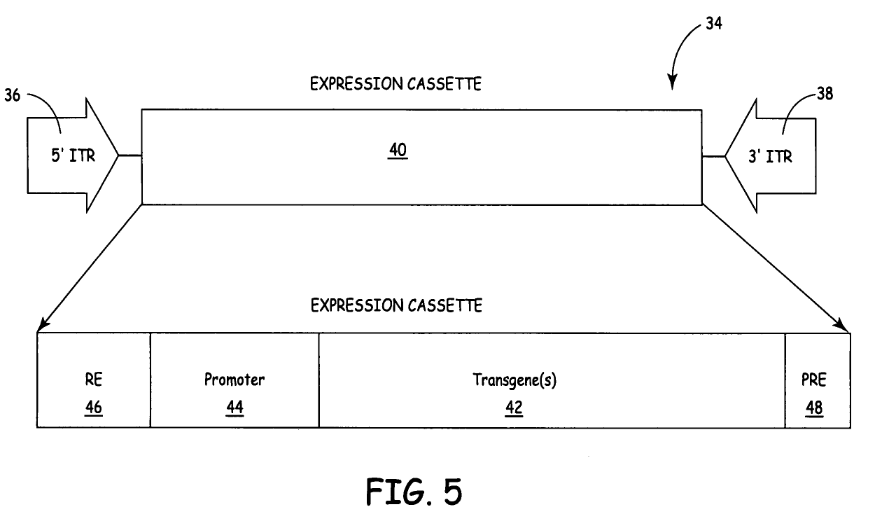

FIG. 5 schematically shows a general form of a nucleic acid construct for gene expression that may be delivered via a viral vector to cells 28 for genetic intervention. Construct 34 shows 5′ and 3′ inverted terminal repeats (ITR) from a viral genome, which ensure high level expression of the transgene(s) following delivery of the viral vector, and expression cassette 40.

Expression cassette 40 includes transgene(s) 42 of interest such as Cx43, Cx40, or the genes encoding the sodium and/or calcium channel subunits. Expression cassette 40 also includes promoter 44 and regulatory elements (RE) 46 such as enhancers or drug-sensitive elements to regulate expression. Some regulatory elements may be positioned downstream from transgene(s) 42 depending on specific mechanisms of action. The construct also includes post-regulatory elements (PRE) 48, which encode, for example, termination signals.

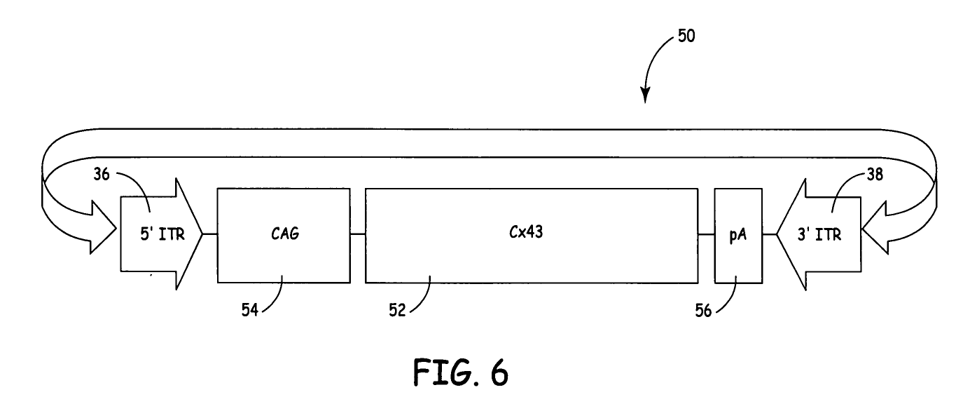

FIG. 6 schematically shows Cx43 viral construct 50 for use with the present invention. Construct 50, again, includes 5′ and 3′ ITRs 36 and 38. Cx43 transgene 52 is expressed via chicken □-actin promoter/CMV enhancer (CAG) 54, which is the promoter and regulatory element utilized in the construct. The post-regulatory element encodes polyA tail (pA) 56. An example of polyA tail 56 used in construct 50 is a bovine growth hormone polyA tail (BGHpA). Based on the packaging size of the viral constructs, the viral vector may be an adeno-associated virus (AAV), a gutless virus, a lentivirus, or any similar type virus.

It may be desirable to use cardiac tissue specific promoters that allow cardiac myocyte specific expression of the transgene(s) instead of, for example, the chicken □-actin promoter. In other embodiments, it is desirable to use inducible/suppressible promoters versus constitutively active promoters. Examples of genes or elements specifically expressed in cardiac tissue having promoters or regulatory elements that may be utilized with the present invention include: cardiac ankyrin repeat protein, □-myosin heavy chain, □-myosin heavy chain, myosin light chain enhancer, myosin heavy chain, myosin light chain 2a, cardiac □-actin gene, cardiac M2 muscarinic acetylcholine, atrial natriuretic factor/peptide (ANF/P), cardiac troponin C, cardiac troponin I, cardiac troponin T, and cardiac sarcoplasmic reticulum Ca-ATPase.

In some embodiments it is desirable to use drug-responsive promoters. Promoters may be induced by ecdysone or erythromycin (macrolides), for example. Tetracycline-responsive elements may be used for suppressible promoters.

Alternatively, an electrically-responsive promoter is used, where gene expression occurs subsequent to electrical stimulation. U.S. Patent Application No. 2003/0204206, assigned to Medtronic, Inc., discloses an electrically-responsive promoter that may be used in the present invention.

The genetic elements and constructs described above are provided as examples. Other vectors, constructs, elements, etc. can also be used with the present invention.

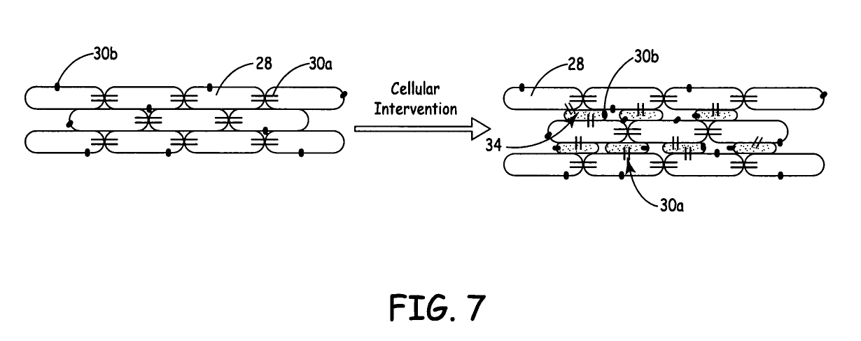

FIG. 7 is a schematic representation of cellular intervention. As in FIG. 4, the border zone is shown having cardiac cells 28 with gap junctions 30a and sodium/calcium channels 30b. Here, however, cells 34, which express connexins and/or sodium channel subunits and/or calcium channel subunits and are capable of forming gap junctions 30a and/or channels 30b, are delivered to the border zone. Hemichannels of exogenously delivered cells couple to the native cardiomyocytes and to each other to provide alternative paths for current flow, thus enhancing effective intercellular coupling. The sodium/calcium channels in the delivered cells provide additional current during excitation and help improve macroscopic excitability of the border zone region.

A number of types of cells 34 may be utilized for cellular intervention. Cells 34 may be autologous, allogenic, or xenogenic. In one embodiment, cells 34 are mesenchymal stem cells (MSCs), which have been shown to integrate and form gap junctions with adult stem cells in vitro. See V. Valiunas et al., J Physiol 6:6. The advantage of using autologous MSCs, for example, is that the cells are not rejected by the host. However, harvesting and expanding MSCs is difficult. Allogenic MSCs from established cell lines overcome the need to harvest and expand cells; however, there is a risk of rejection by the host. Xenogenic MSCs also present a risk of rejection by the host. Allogenic and xenogenic MSCs may be cultured and treated prior to implantation in order to reduce the risk of rejection.

Other examples of cells 34 include fibroblasts of variable origin (cardiac, dermal, etc.) or skeletal muscle cells. Cells 34 may also be transfected ex vivo or in vitro to express one or more desired connexins and/or sodium channel subunits and/or calcium channel subunits and then delivered to the border zone.

Other examples of cell types useful in this invention are, but are not limited to: 1) autologeous cells: stem cells and progenitor cells derived from bone marrow and from blood; skeletal muscle progenitor cells (skeletal muscle myoblasts or adult stem cells derived from skeletal muscle are synonyms); cardiac progenitor cells (c-kit+); other stem cells; other cells; 2) allogeneic cells: mesenchymal stem cells; other stem cells derived from bone-marrow or blood; embryonic stem cells; other expandable cells that are able to electrically couple and conduct cardiac impulses.

Cells 34 may include any combination of cells described above or similar types of cells. For example, a combination of stem cells and fibroblasts, transfected with a Cx gene, may be injected separately or together. Here, the stem cells may not form the gap junctions but, instead, provide necessary growth factors and chemotactic factors for homing of fibroblasts and subsequent coupling to the myocytes.

In another embodiment, one or more growth factors may be injected into the border zone tissue prior to delivery of cells. The growth factors prepare the border zone tissue for maintaining exogenous cells by providing a more optimal environment.

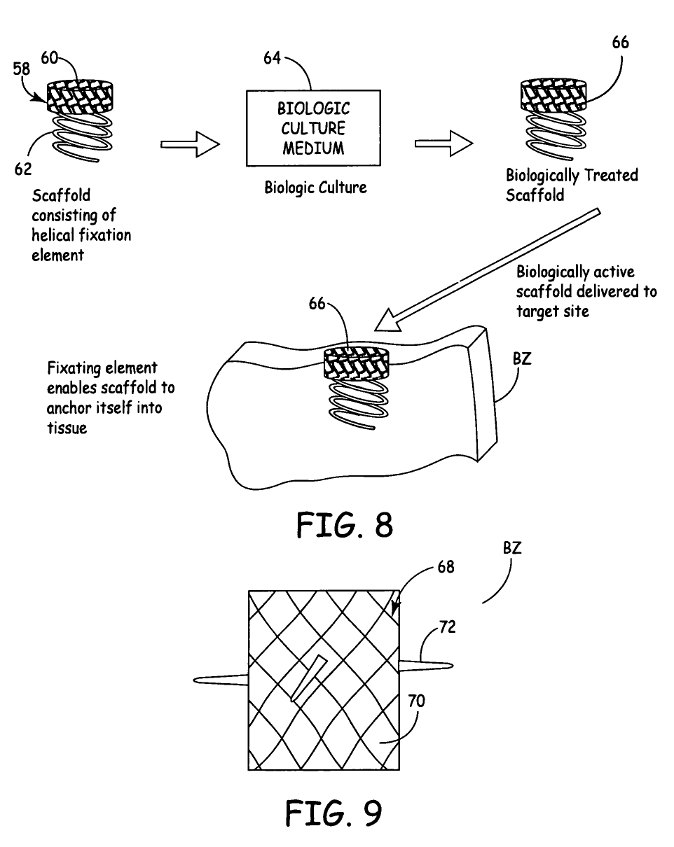

The in vivo delivery of biological materials is associated with several problems. The prior art exhibits about 80% to 90% loss of delivered material by mechanical, vascular, or lymphatic mechanisms, which, in all cases, may transport the biological material within the systemic circulation potentially resulting in ineffective treatment or deleterious effects. If the delivered material is cells, about 80% to 90% of the delivered cells typically undergo cell death due to lack of vasculature within the target tissue. The Inventors posit that cellular death is associated with a lack of necessary nutrients and gaseous exchange. To address these issues, a scaffold may be used in the delivery of the biological material to the border zone. In some cases, it may be desirable to use a self-fixating scaffold. The scaffolds utilized in the present invention are polymeric and biodegradable. A self-fixating scaffold allows for less invasive delivery procedures, because no sutures are required to anchor the scaffold. FIG. 8 is a first embodiment of a scaffold utilized in the present invention. FIG. 8 includes scaffold 58 having support 60 and fixation element 62. Support 60 retains the biological material while fixation element 62 anchors scaffold 58 into the tissue of border zone BZ.

In the embodiment shown, scaffold 58 is fabricated and impregnated with the biological material in vitro. However, biological material may be delivered to scaffold 58 after its delivery to border zone BZ. Scaffold 58 is cultured in culture medium 64. Culture medium 64 contains the biological material, genetic or cellular, to enhance conduction. It may also contain other factors, such as growth factors and nutrients, which enhance cell viability. Once cultured, scaffold 66 is delivered to border zone tissue BZ.

Impregnating scaffold 58 prior to delivery to border zone BZ confers several advantages. It provides a matrix within which cells grow when introduced into the tissue. It will hold the biological material thereby reducing leakage. Nucleic acid may be coaxed to adhere to surfaces of scaffold 58. Because impregnated cells have adapted to the environment of scaffold 58 prior to delivery to the tissue, the cells face less stress then they would if injected directly into the tissue.

Successful treatment using cellular intervention depends, in part, on incorporation of the implanted cells between cells that form border zone BZ. Therefore, in one embodiment, chemotactic factors such as insulin-like growth factor-1 (IGF-1) are injected into border zone tissue BZ in order to attract the cells into region BZ. Fixation element 62 may be hollow such that scaffold 58 is also an injection device. If repair is performed on a recent infarct, injection of chemotactic factors may not be necessary, because tissue BZ is adequately producing an effective amount of chemotactic factors.

FIG. 9 shows a second embodiment of a scaffold. Scaffold 68 includes support 70 and arms 72. Arms 72 are spring-loaded or made of a shape memory material such as nitinol. Upon delivery, arms 72 open and anchor scaffold 68 in border zone tissue BZ.

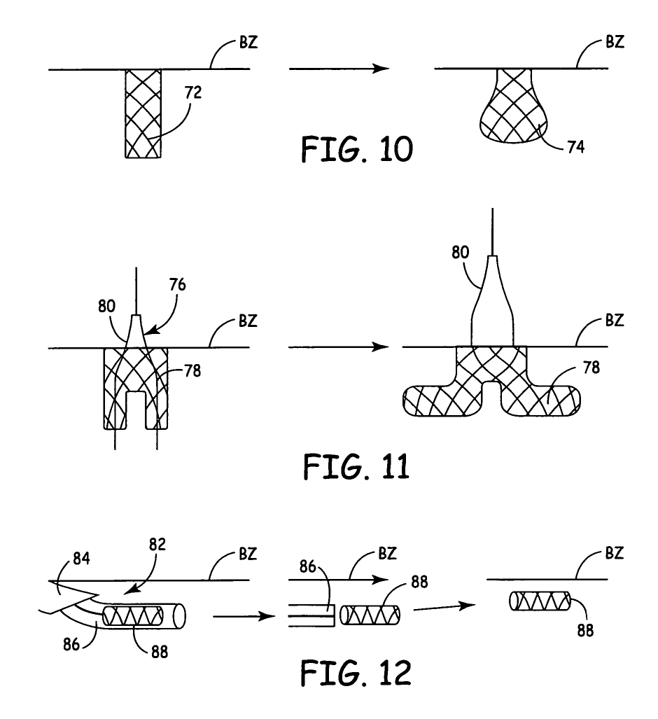

FIG. 10 shows a third embodiment of a scaffold. Here, scaffold 74 is implanted into the tissue of border zone BZ. Scaffold 74 is shaped for ease of implantation as shown in FIG. 10. Once implanted, portion 74 of scaffold 72 expands to anchor scaffold 72 in tissue BZ.

FIG. 11 is a fourth embodiment of a scaffold. FIG. 11 shows scaffold device 76 with scaffold 78 and skeleton 80. Skeleton 80 is formed from a metallic or similar material. In operation, scaffold device 76 is implanted into border zone BZ. Skeleton 80 provides stiffness to scaffold 78 for penetrating tissue BZ. Once implanted, skeleton 80 is removed resulting in portions 78a and 78b of scaffold 78 changing form. Portions 78a and 78b anchor scaffold 78 within tissue BZ after implantation.

FIG. 12 shows a fifth embodiment of a scaffold. Scaffold system 82 includes needle 84, catheter 86, and scaffold 88. In operation, scaffold system 82 is inserted into border zone BZ such that scaffold 88 is nearly parallel to the surface of the tissue. Needle 84 is retracted followed by retraction of catheter 86. Scaffold 88 remains implanted within the tissue of border zone BZ.

The embodiments shown above are all fabricated in vitro and may or may not be impregnated with biological material prior to delivery into the border zone. The embodiments are examples of self-fixating scaffolds and are not meant to be limiting.

If biological material is delivered by injection, spherical scaffolds, fabricated from similar materials and impregnated with biological material, are injected into the border zone. The size of the scaffolds relative to the biological material reduces the chance of the scaffolds being washed away as they obstruct their own washout pathways. The spherical scaffold also initially buffers the biological material from the environment of the tissue.

In alternate embodiments, scaffolds may be fabricated in vivo. An injectable polymer is injected into the border zone. The injectable polymer forms a polymeric and biodegradable scaffold and may be mixed, or impregnated, with the biological material prior to injection.

Upon injection, the injectable polymer undergoes a phase transition that may be driven by temperature or the presence of calcium ions, for example. Thus, once formed, the scaffold is self-fixated within the tissue.

Any of the scaffolds described above may be used with other biological materials and be delivered to other tissues than those described here. The use of scaffolds with the present invention provides several advantages. Scaffolds effectively deliver a predetermined quantity of biological material to the border zone and enable focal, localized delivery. Cells impregnated in a scaffold have a matrix within which to grow and will face less stress upon being delivered to the border zone, because the scaffold provides a shelter from drastic environmental changes. Lastly, the scaffold acts as a biomechanical skeleton to reduce leakage of biological material.

Cardiac tissue shows anisotropic propagation—the action potential propagates faster along the direction of the myocardial fibers than transverse to it. The axis of anisotropy rotates along the thickness of the myocardium from the endocardial to the epicardial layer. The scaffolds may be engineered with a specific lattice structure such that the cells of the border zone have desired anisotropy. Biological material that is injected without a scaffold presumably integrates randomly into the tissue, thus forming an isotropic structure. Scaffolds aid in overcoming random integration to properly orient the cells and increase the success of electrically repairing the border zone of an infarct.

Scaffolds used with the present invention may be fabricated from any one or more of a number of polymers. Because the fixation elements of the scaffolds need to penetrate the tissue and be robust enough to resist being dislodged from the tissue, these are fabricated from a different polymer than that of the support that carries the biological material. In some instances, the fixation element is fabricated from a metallic material such as platinum. Examples of polymers that may be used in fabricating the scaffolds include the following: synthetic polymers such as PLA:poly(lactic acid), PGA:poly(glycolic acid), PLGA:poly(D, L-lactic-co glycolide), PEG:polyethylene glycol, PCL:poly(e-caprolactone), PLLA, polyurethane-PCL, polyurethane-PEO:poly ethylene oxide, PCLA:polymer of e-caprolactone-co-L-lactide reinforced with knitted poly-L-lactide fabric, and diblock, triblock, and pentablock copolymer variants of the above; natural polymers such as alginate, collagen, starch/cellulose, cellulose acetate, fibrin, platelet gel, gelatin, chitin, pectin, and hyaluronic acid polymers; combination products such as collagen/PLA, pectin/PLGA, and chitin/PLGA; and injectable polymers such as oligopeptides, alginates, fibrin, and platelet gel (thrombin and platelet combination).

In addition, it may be desirable to stabilize the heart tissue while the scaffolds are implanted into the border zone. This can be done by any of a number of ways, including the induction of asystole of the heart or stabilizing a local region of the heart receiving the scaffold.

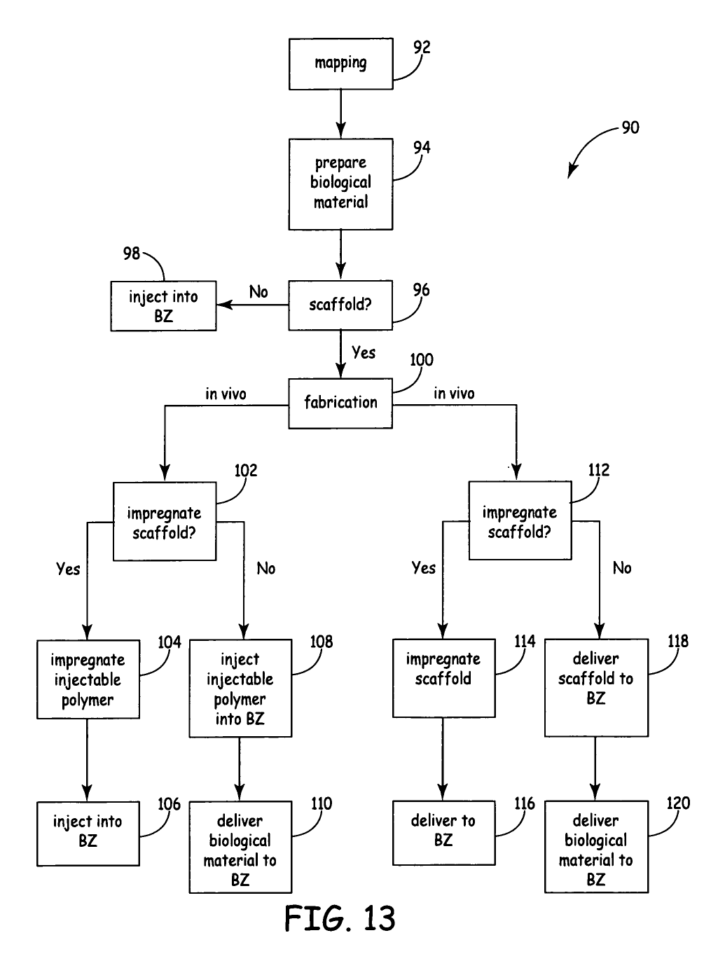

FIG. 13 illustrates pathways 90 for utilizing various embodiments of the present invention. Each pathway begins, at step 92, by locating and mapping the infarct. Intracardiac electrocardiographic techniques, electrophysiology (EP) studies, or a mapping catheter may be used to analyze cardiac impulse information and conduction. Any of a number of cardiac mapping techniques may be used. A mapping and delivery technique that may be used is described in U.S. application Ser. No. 10/837,947, assigned to Medtronic, Inc. These and other mapping techniques will identify the infarct with encompassing border zone.

Step 94 shows that biological material is prepared. The biological material may be nucleic acid, protein, or cells.

A self-fixating scaffold may or may not be used for holding the biological material at the target site as shown at step 96. If no self-fixating scaffold is used, the genetic material is typically injected directly into the target tissue of the border zone as shown in step 98. However, any of a number of methods may be used to deliver the biological material to the border zone, and these methods are well known in the art.

If a scaffold is utilized, the method of fabrication of the scaffold, step 100, may be either in vivo or in vitro. In one pathway, a scaffold fabricated in vivo may or may not be impregnated with biological material, step 102, prior to delivery to the tissue. At step 104, the biological material is prepared in any of the forms previously discussed. An injectable polymer is prepared and mixed with the biological material at step 104. At step 106, the injectable polymer and biological material are delivered to the border zone.

In another pathway, the biological material is not impregnated into the injectable polymer. The injectable polymer is delivered to the border zone as shown by step 108. After the injectable polymer has undergone the phase transition to become a scaffold, the biological material is delivered to the border zone, as shown in step 110.

An in vitro fabricated scaffold may or may not be impregnated with material prior to delivery, step 112. At step 114, the scaffold is prepared and impregnated with the biological material. The scaffold impregnated with the biological material is then delivered to the border zone as shown in step 116.

In an alternate pathway, the scaffold is not impregnated prior to delivery. The scaffold is delivered to the border zone as shown in step 118. The biological material is subsequently delivered to the scaffold at the border zone. This is shown as step 120.

The present invention overcomes limitations of many of the currently available treatments for VT. It decreases the propensity of experiencing VT, especially in individuals predisposed to VT storms, which results in decreased dependence on ICDs and extended ICD longevity.

All patents, patent applications, and articles disclosed herein are incorporated by reference. Although the present invention has been described with reference to preferred embodiments, workers skilled in the art will recognize that changes may be made in form and detail without departing from the metes and bounds and scope of the invention.

### EXAMPLES

### Series A Examples

The foregoing wherein the proteins include at least one of angiotensin II and endothelin.

The foregoing wherein the biological material includes cells capable of forming gap junctions with myocytes.

The foregoing wherein the biological material includes cells capable of forming sodium channels.

The foregoing wherein the biological material includes cells capable of forming calcium channels.

The foregoing wherein the biological material includes autologous cells.

The foregoing wherein the biological material includes allogenic cells.

The foregoing wherein the biological material includes xenogenic cells.

The foregoing wherein the biological material includes mesenchymal stem cells.

The foregoing wherein the biological material includes genetically engineered cells.

The foregoing wherein the biological material includes at least one gap junction protein.

The foregoing wherein the biological material includes at least one sodium channel protein.

The foregoing wherein the biological material includes at least one calcium channel protein.

The foregoing and further comprising impregnating the biological material into a scaffold.

The foregoing wherein at least part of the scaffold is fabricated of a biodegradable polymer.

The foregoing wherein the scaffold is a self-fixating scaffold.

The foregoing wherein the self-fixating scaffold is fabricated in vitro.

The foregoing wherein the self-fixating scaffold is fabricated from at least one of: PLA, PGA, PLGA, PEG, PCL, polyurethane-PCL, polyurethane-PEO, PCLA, alginate, collagen, starch/cellulose, cellulose acetate, fibrin, platelet gel, gelatin, chitin, pectin, and hyaluronic acid.

The foregoing wherein the self-fixating scaffold is fabricated in vivo.

The foregoing wherein the self-fixating scaffold is fabricated from at least one of: oligopeptides, alginate, fibrin, and platelet gel.

The foregoing and further comprising delivering at least one chemotactic factor to the border zone.

The foregoing and further comprising delivering at least one stem cell to the border zone to provide at least one chemotactic factor.

### Series B Examples

A method of decreasing risk of ventricular tachycardia associated with an infarcted region of myocardial tissue, the method comprising:

preparing at least one cell capable of enhancing electrical conduction for delivery to a border zone of the infarcted region; and

contacting at least one myocyte within the border zone with the cell to enhance electrical conduction within the border zone of the infarcted region.

The foregoing wherein the cell is delivered to and contacts the myocyte within an endocardial border zone.

The foregoing wherein the cell is a mesenchymal stem cell.

The foregoing wherein the cell forms at least one gap junction with the myocyte.

The foregoing wherein the cell forms at least one sodium channel.

The foregoing wherein the cell forms at least one calcium channel.

The foregoing wherein the cell is genetically engineered to express at least one connexin protein.

The foregoing wherein the cell is genetically engineered to express at least one sodium channel protein.

The foregoing wherein the cell is genetically engineered to express at least one calcium channel protein.

The foregoing wherein the cell is autologous.

The foregoing wherein the cell is allogenic.

The foregoing 33 wherein the cell is xenogenic.

The foregoing and further comprising implanting a scaffold in the border zone.

The foregoing and further comprising injecting at least one chemotactic factor into tissue surrounding the scaffold.

The foregoing wherein the scaffold is a self-fixating scaffold.

The foregoing 33 and further comprising impregnating a self-fixating scaffold with the at least one cell.

### Series C Examples

A method of treating a cardiac conductance disturbance associated with an infarcted region of myocardial tissue, the method comprising:

preparing a biological material capable of enhancing electrical conduction within an endocardial border zone of the infarcted region; and

delivering the biological material to the endocardial border zone.

The foregoing wherein the biological material increases expression of connexins in cells within the endocardial border zone.

The foregoing wherein the biological material increases expression of sodium channel proteins within the endocardial border zone.

The foregoing wherein the biological material increases expression of calcium channel proteins within the endocardial border zone.

The foregoing wherein the biological material is cells capable of forming gap junctions with myocytes within the endocardial border zone.

The foregoing wherein the biological material is cells capable of forming sodium channels within the endocardial border zone.

The foregoing wherein the biological material is cells capable of forming calcium channels within the endocardial border zone.

The foregoing wherein delivering further comprises impregnating an injectable polymer with the biological material; and injecting the injectable polymer impregnated with biological material into the endocardial border zone;

wherein the injectable polymer undergoes a phase transition to form a self-fixating scaffold.

### Series D Examples

A method for decreasing risk of future ventricular tachycardia associated with a region of myocardial infarcted tissue, the method comprising:

impregnating a scaffold with biological material that enhances electrical conduction; and

delivering the scaffold impregnated with the biological material to an endocardial border zone of an infarct associated with the conduction disturbance.

The foregoing the biological material is cells that form gap junctions with myocytes within the endocardial border zone.

The foregoing wherein the biological material is cells that form sodium channels within the endocardial border zone.

The foregoing 57 wherein the biological material is cells that form calcium channels within the endocardial border zone.

The foregoing wherein the scaffold has a lattice structure that preserves anisotropy within the endocardial border zone.

The foregoing and further comprising injecting at least one chemotactic factor into tissue surrounding the scaffold.

The foregoing 57 wherein the injecting is via a fixation element of the self-fixating scaffold.

### Series E Examples

A method for decreasing risk of ventricular tachycardia associated with a region of previously infarcted tissue, the method comprising:

preparing a plurality of cells that enhance electrical conduction within a border zone of an infarct; and

contacting the cells with myocytes within the border zone of the infarct.

The foregoing wherein the cells are mesenchymal stem cells.

The foregoing wherein the cells are autologous.

The foregoing 64 wherein the cells are allogenic.

The foregoing wherein the cells are xenogenic.

The foregoing wherein cell-to-cell coupling via gap junctions enhances electrical conduction.

The foregoing wherein increased excitability via at least one of sodium channels and calcium channels enhances electrical conduction.

### Series F Examples

A method for treating an electrical conductance disturbance associated with a previous cardiac insult, the method comprising:

determining a location of a surface of a subsurface region of an infarct of a heart;

preparing biological material capable of enhancing electrical conduction within a border zone of the infarct; and

delivering the biological material to the border zone.

The foregoing wherein the biological material increases gap junctions in the border zone.

The foregoing wherein the biological material increases sodium channels in the border zone.

The foregoing wherein the biological material increases calcium channels in the border zone.

The foregoing wherein the biological material is delivered to one of an endocardial border zone a mid-myocardial myocardium.

The foregoing wherein the biological material is delivered to epicardial myocardium.

What is claimed is:

1. A method of treating an electrical conductance disturbance in an infarcted region of myocardial tissue, the method comprising:
preparing a biological material capable of improving electrical conduction within a border zone of an infarcted region; and
delivering the biological material to the border zone of the infarcted region.

2. The method of claim 1 wherein the biological material is delivered to an endocardial border zone.

3. The method of claim 1 wherein the biological material includes nucleic acid encoding at least one gap junction protein.

4. The method of claim 3 wherein the nucleic acid encodes connexin 43 protein.

5. The method of claim 3 wherein the nucleic acid encodes connexin 40 protein.

6. The method of claim 1 wherein the biological material includes nucleic acid encoding at least one sodium channel protein.

7. The method of claim 6 wherein the nucleic acid encodes sodium channel protein.

8. The method of claim 1 wherein the biological material includes nucleic acid encoding at least one calcium channel protein.

9. The method of claim 8 wherein the nucleic acid encodes at least one of L-type calcium channel protein and T-type calcium channel subunit protein.

10. The method of claim 1 wherein the biological material encodes proteins that increase expression of gap junction proteins.

11. A method for decreasing risk of ventricular tachycardia associated with a region of previously infarcted tissue, the method comprising:
preparing a plurality of cells that enhance electrical conduction within a border zone of an infarct; and
contacting the cells with myocytes within the border zone of the infarct.

12. The method of claim 11 wherein the cells comprise one of: autologous, mesenchymal stem cells, allogenic, xenogenic.

13. The method of claim 11 wherein cell-to-cell coupling via gap junctions enhances electrical conduction.

14. The method of claim 11 wherein increased excitability via at least one of sodium channels and calcium channels enhances electrical conduction.

15. A method for treating an electrical conductance disturbance associated with a previous cardiac insult, the method comprising:
determining a location of a surface of a subsurface region of an infarct of a heart;
preparing biological material capable of enhancing electrical conduction within a border zone of the infarct; and
delivering the biological material to the border zone.

16. A method of decreasing risk of ventricular tachycardia associated with an infarcted region of myocardial tissue, the method comprising:
preparing at least one cell capable of enhancing electrical conduction for delivery to a border zone of the infarcted region; and
contacting at least one myocyte within the border zone with the cell to enhance electrical conduction within the border zone of the infarcted region.

17. The method of claim 16 wherein the cell is delivered to and contacts the myocyte within an endocardial border zone.

18. The method of claim 16 wherein the cell is a mesenchymal stem cell.

19. The method of claim 16 wherein the cell forms at least one gap junction with the myocyte.

20. The method of claim 16 wherein the cell forms at least one sodium channel.
